(19) United States
(12) Patent Application Publication
(10) Pub. No.: US 2020/0081293 A1
(43) Pub. Date: Mar. 12, 2020

(54) PIXEL ARRANGEMENT AND METHOD FOR MANUFACTURING DISPLAY PANEL

(71) Applicant: HKC CORPORATION LIMITED, Shenzhen, Guangdong (CN)

(72) Inventor: Beizhou HUANG, Shenzhen, Guangdong (CN)

(21) Appl. No.: 16/313,861

(22) PCT Filed: Nov. 13, 2018
(86) PCT No.: PCT/CN2018/115222

§ 371 Date: Dec. 27, 2018

(30) Foreign Application Priority Data
Sep. 7, 2018 (CN) 201811042605.1

(51) Int. Cl. G02F 1/1335; G09G 3/36

(52) U.S. Cl. CPC G02F 1/133516; G02F 1/133609; G09G 3/3696

(57) ABSTRACT

A pixel arrangement, including a plurality of pixel assemblies, each of the pixel assemblies includes a main photic zone and a secondary photic zone, and the main photic zone and the secondary photic zone are respectively one of a bright zone and a dark zone, depending on a respective input voltage value thereof.

### CROSS-REFERENCE TO RELATED APPLICATION

This application is the US national stage application of PCT International Application No. PCT/CN2018/115222, which was filed Nov. 13, 2018 and claimed priority to Chinese Patent Application No. 201811042605.1, filed on Sep. 7, 2018. The content of Chinese Patent Application No. 201811042605.1 is incorporated herein by reference.

### TECHNICAL FIELD

The present application relates to display technical field, and more particularly to a pixel arrangement and a method for manufacturing a display panel.

### BACKGROUND

The liquid crystal display panel is usually composed of a color filter (CF), a thin film transistor array substrate (TFT Array Substrate), and a liquid crystal layer (LC layer) disposed between the two substrates, the operating principle thereof is to control the rotation of the liquid crystal molecules of the liquid crystal layer by applying a drive voltage on the two glass substrates, and refract the light of the backlight assembly to generate a picture. According to different orientation modes of liquid crystals, liquid crystal display panels on the mainstream market can be classified into the following types: Vertical Alignment (VA) type, Twisted Nematic (TN) type or Super Twisted Nematic (STN) type, In-Plane Switching (IPS) type, and Fringe Field Switching (FFS) type.

The Vertical Alignment type (VA) mode liquid crystal display, such as a Patterned Vertical Alignment (PVA) liquid crystal display or a Multi-domain Vertical Alignment (MVA) liquid crystal display device, in which the PVA type adopts a fringe field effect and a compensation plate to achieve a wide viewing angle. The MVA type divides a single pixel into a plurality of zones, and uses a protrusion or a specific pattern structure to cause liquid crystal molecules located in different zones to be tilted in different directions to achieve a wide viewing angle and enhance the transmittance.

In the IPS mode or the FFS mode, liquid crystal molecules are driven to respond in a direction parallel to the plane of the substrate by applying an electric field containing a component substantially parallel to the substrate. The IPS type liquid crystal display panel and the FFS type liquid crystal display panel have the advantages of wide viewing angle. However, since the wavelength of blue light is shorter, the phase retardation required to achieve the same transmittance is smaller when compared with red light and green light, and the transmittance-voltage (VT) of red light, green light, and blue light curves are different; moreover, red light, green light, and blue light have different transmittances in the polyimide (PI) film, flattening layer (PFA), and coating layer (OC) in the panel, which may cause color shift problems.

### SUMMARY

An object of the present application is to provide a pixel arrangement, including but not limited to solve a technical problem of color shift.

In order to solve the above technical problem, the technical solution adopted by the embodiment of the present application is to provide a pixel arrangement, including: a plurality of pixel assemblies, the pixel cell including:

a photic zone, including a main photic zone and a secondary photic zone adjacent to each other;

a color resist arrangement, disposed on the photic zone, the color resist arrangement including a red color resist layer, a green color resist layer, a blue color resist layer; and a white color resist layer, a secondary red color resist layer, a secondary green a color resist layer, and a secondary blue color resist layer that are oppositely disposed;

the red color resist layer, the green color resist layer, and the blue color resist layer are disposed at the main photic zone; the white color resist layer, the secondary red color resist layer, the secondary green color resist layer, and the secondary blue color resist layer are disposed at the secondary photic zone; the main photic zone and the secondary photic zone are respectively one of a bright zone and a dark zone, depending on a respective input voltage value thereof, such that the bright zone and the dark zone cooperate with each other to achieve a low color shift effect.

In an embodiment of the present application, the red color resist layer is disposed opposite to the secondary red color resist layer, the green color resist layer is disposed opposite to the secondary green color resist layer, and the blue color resist layer is disposed opposite to the secondary blue color resist layer.

In an embodiment of the present application, the secondary red color resist layer, the secondary green color resist layer, and the secondary blue color resist layer are disposed sequentially.

In an embodiment of the present application, an input voltage of the main photic zone and an input voltage of the secondary photic zone are adjustable such that a brightness of the main photic zone is higher than a brightness of the secondary photic zone.

In an embodiment of the present application, the red color resist layer, the green color resist layer, and the blue color resist layer are in a rectangular shape.

In an embodiment of the present application, the white color resist layer, the secondary red color resist layer, the secondary green color resist layer, and the secondary blue color resist layer are in a rectangular shape.

Another object of the present application is to provide a pixel arrangement, including: a plurality of pixel assemblies, the pixel cell including:

a photic zone, including a main photic zone and a secondary photic zone adjacent to each other;

a color resist arrangement, disposed on the photic zone, the color resist arrangement including a red color resist layer, a green color resist layer, a blue color resist layer; and a white color resist layer, a secondary red color resist layer, a secondary color resist layer and a secondary blue color resist layer that are oppositely disposed;

the red color resist layer, the green color resist layer, and the blue color resist layer are disposed at the main photic zone; the white color resist layer, the secondary red color resist layer, the secondary green color resist layer, and the secondary blue color resist layer are disposed at the secondary photic zone; the main photic zone and the secondary photic zone are respectively one of a bright zone and a dark zone, depending on a respective input voltage value thereof, such that the bright zone and the dark zone cooperate with each other to achieve a low color shift effect; the red color resist layer is disposed opposite to the secondary red color resist layer, the green color resist layer is disposed opposite to the secondary green color resist layer, and the blue color resist layer is disposed opposite to the secondary blue color resist layer; the secondary red color resist layer, the secondary green color resist layer, and the secondary blue color resist layer are disposed sequentially; and a proportion of an area of the main photic zone to an area of the secondary photic zone ranges from 1.5 to 4.

In an embodiment of the present application, an input voltage of the main photic zone and an input voltage of the secondary photic zone are adjustable such that a brightness of the main photic zone is higher than a brightness of the secondary photic zone.

In an embodiment of the present application, the red color resist layer, the green color resist layer, and the blue color resist layer are in a rectangular shape.

In an embodiment of the present application, the white color resist layer, the secondary red color resist layer, the secondary green color resist layer, and the secondary blue color resist layer are in a rectangular shape.

A further object of the present application is to provide a method for manufacturing a display panel, including:

providing a first base, the first substrate including a plurality of pixel assemblies, the pixel cell includes a photic zone, and the photic zone includes a main photic zone and a secondary photic zone adjacent to each other;

forming a first insulation layer on the first base;

forming a color filter layer on the first insulation layer, the color filter layer includes a red color resist layer, a green color resist layer, a blue color resist layer; and a white color resist layer, a secondary red color resist layer, a secondary color resist layer and a secondary blue color resist layer that are oppositely disposed; and the red color resist layer, the green color resist layer, and the blue color resist layer are disposed at the main photic zone; the secondary red color resist layer, the secondary green color resist layer, and the secondary blue color resist layer are disposed on the secondary photic zone;

forming a protection layer on the color filter layer;

forming a first electrode layer on the protection layer to complete the first substrate;

providing a second substrate disposed opposite to the first substrate to form the display panel;

the main photic zone and the secondary photic zone are respectively one of a bright zone and a dark zone, depending on a respective input voltage value thereof, such that the bright zone and the dark zone cooperate with each other to achieve a low color shift effect.

In an embodiment of the present application, the step of forming a color filter layer on the first insulation layer including:

forming a color resist material layer on an entire surface of the first insulation layer;

forming a photoresist layer on the color resist material layer to cover the color resist material layer;

disposing a photomask on the photoresist layer, the photomask having a photic zone, a non-photic zone, and a semi-photic zone;

performing an exposure process and a development process on the photoresist layer for patterning the photoresist layer;

using the photoresist layer as a barrier layer, etching the color resist material layer to form a color resist layer of a corresponding color;

manufacturing the white color resist layer, the red color resist layer, the green color resist layer, the blue color resist layer, the secondary red color resist layer, the secondary green color resist layer, and the secondary blue color resist layer; the red color resist layer and the secondary red color resist layer are manufactured by a same photomask process, the green color resist layer and the secondary green color resist layer are manufactured by a same photomask process, and the blue color resist layer and the secondary blue color resist layer are manufactured by a same photomask process to form the color filter layer.

In an embodiment of the present application, the step of forming a color filter layer on the first insulation layer including:

forming a color resist material layer on an entire surface of the first insulation layer;

forming a photoresist layer on the color resist material layer to cover the color resist material layer;

disposing a photomask on the photoresist layer, the photomask having a photic zone, a non-photic zone, and a semi-photic zone;

performing an exposure process and a development process on the photoresist layer for patterning the photoresist layer;

using the photoresist layer as a barrier layer, etching the color resist material layer to form a color resist layer of a corresponding color;

respectively manufacturing the white color resist layer, the red color resist layer, the green color resist layer, the blue color resist layer, the secondary red color resist layer, the secondary green color resist layer and the blue color resist layer in a method described above to form the color filter layer.

In an embodiment of the present application, the red color resist layer, the green color resist layer, and the blue color resist layer are in a rectangular shape.

In an embodiment of the present application, the white color resist layer, the secondary red color resist layer, the secondary green color resist layer, and the secondary blue color resist layer are in a rectangular shape.

Each of the pixel assemblies in the present application are configured to include a main photic zone and a secondary photic zone adjacent to each other, and the main photic zone and the secondary photic zone are respectively one of a bright zone and a dark zone, depending on a respective input voltage value thereof, so there is a multi-category compensation effect under the large viewing angle, such that the bright zone and the dark zone cooperate with each other to achieve a low color shift effect, in addition, the area proportion of bright area to dark area is appropriately adjusted, and the whitening or color shift problem of the large viewing angle of the display panel can be effectively solved.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1a is an exemplary transmittance-grayscale value curve corresponding to a color shift angle of a vertical alignment type liquid crystal display device in a case of a 0 degree viewing angle, a 45 degree viewing angle, and a 60 degree viewing angle;

FIG. 1b is an exemplary brightness-grayscale value curve corresponding to mixing two pixel areas that improve the color shift angle;

FIG. 2 is an exemplary mixing low color shift area model;

FIG. 3a is a schematic diagram of driving of different color resist layers of a photic zone according to an embodiment of the present application.

FIG. 3b is a drive equivalent circuit diagram of different color resist layers of a photic zone according to an embodiment of the present application.

FIG. 4a is a schematic view of forming a first insulation layer on a first substrate;

FIG. 4b is a schematic view of a photomask process;

FIG. 4c is a schematic view of forming a white color resist on the first base and the first insulation layer;

FIG. 4d is a schematic view of forming a red color resist on the first base and the first insulation layer;

FIG. 4e is a schematic view of forming a green color resist on the first base and the first insulation layer;

FIG. 4f is a schematic view of forming a blue color resist on the first base and the first insulation layer;

FIG. 4g is a schematic view of forming a protection layer on the first base, the first insulation layer, and the color resist layer;

FIG. 4h is a schematic view of forming a pixel electrode layer on a protection layer;

FIG. 4i is a schematic view of providing a second substrate.

### DETAILED DESCRIPTION OF THE EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed at” another component, it can be directly or indirectly on another component. When a component is referred to as being “connected to” another component, it can be directly or indirectly connected to another component. Directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application. Terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present application, “a plurality of” means two or more, unless there is additional explicit and specific limitation.

In order to explain the technical solutions described in the present application, the following detailed description will be made in combination with the specific drawings and embodiments.

The display device of the embodiment of the present application may include a backlight assembly and a display panel. The display panel may include a thin film transistor (TFT) substrate, a color filter (CF) substrate, and a layer formed between the two substrates.

In an embodiment, the display panel of the present application may be a curved display panel, and the device of the present application may also be a curved display device.

In an embodiment, the thin film transistor (TFT) and the color filter (CF) of the present application may be formed on the same substrate.

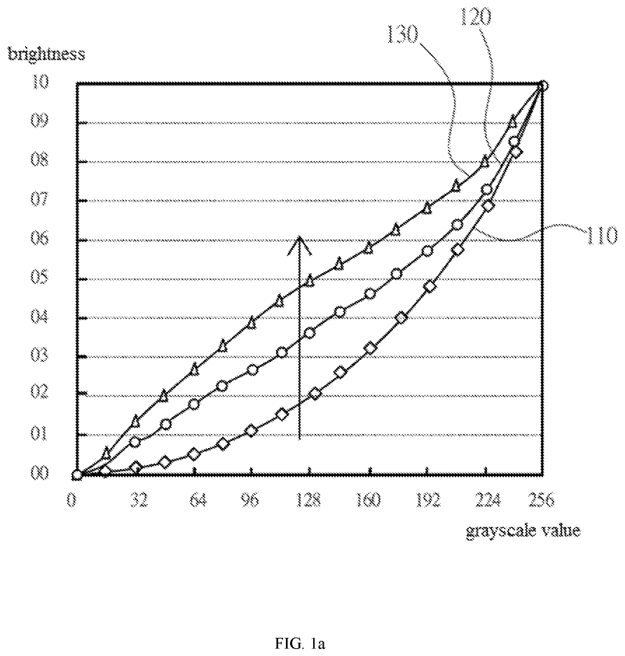

FIG. 1a is an exemplary transmittance-grayscale value curve corresponding to a color shift angle of a vertical alignment type liquid crystal display device in a case of a 0 degree viewing angle, a 45 degree viewing angle, and a 60 degree viewing angle. Please refer to FIG. 1a, the transmittance-grayscale value curve 110 corresponding to the 0 degree color shift viewing angle, the transmittance-grayscale value curve 120 corresponding to the 45 degree color shift viewing angle, and the transmittance-grayscale value curve 130 corresponding to the 60 degree color shift viewing angle. Therefore, in the same grayscale value, the higher the viewing angle, the higher the brightness transmittance.

FIG. 1b is an exemplary brightness-grayscale curve corresponding to mixing two pixel areas that improve the color shift angle. Please refer to FIG. 1b, in an embodiment of the present application, in the current mainstream mode of the MVA mode, the pixel areas are divided into bright zone and dark zone, so that the optical performance can be mixed by two V-T characteristics, and the area proportion between the bright zone and dark zone is adjusted appropriately such that the problem of whitening of the grayscale can be effectively suppressed at a large viewing angle. In the bright zone pixel 140 and the dark zone pixel 150, they are mixed and adjusted into the pixels 160 in the luminance-grayscale pattern.

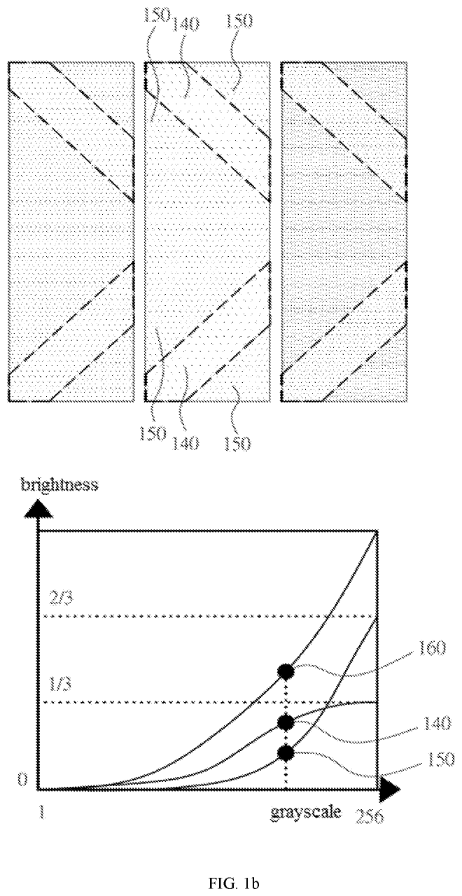

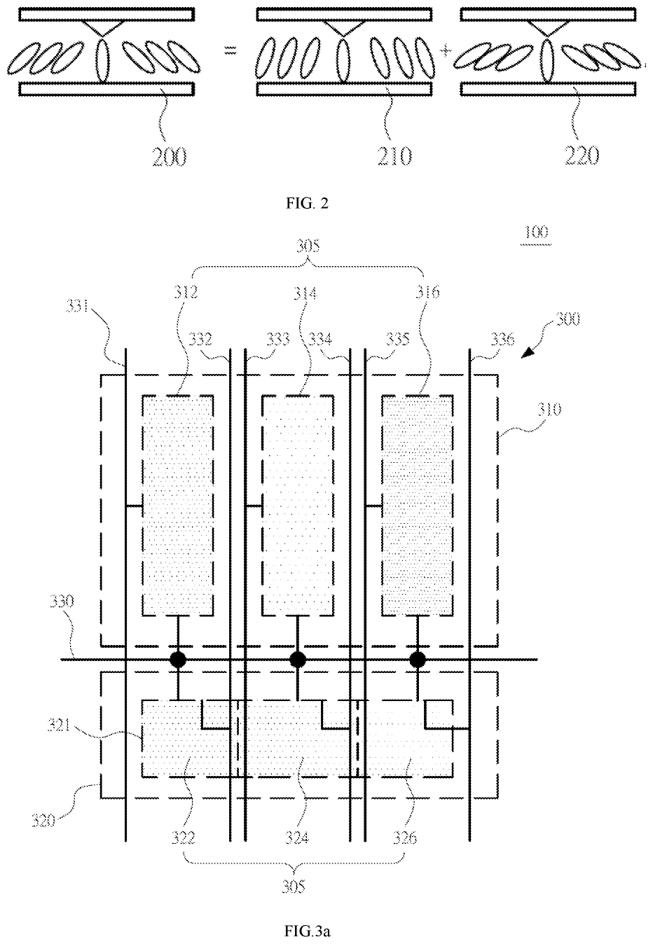

FIG. 2 is an exemplary mixing low color shift area model. Please refer to FIG. 2, in an embodiment of the present application, the main principle of the common low color shift technology is to re-divide the conventional four regions into eight regions by using a partial pressure or an additional drive method. Therefore, there is a multi-domain compensation effect under a large viewing angle, such as the secondary low color shift region 210 and the main low color shift region 220 being mixed into the low color shift area 200.

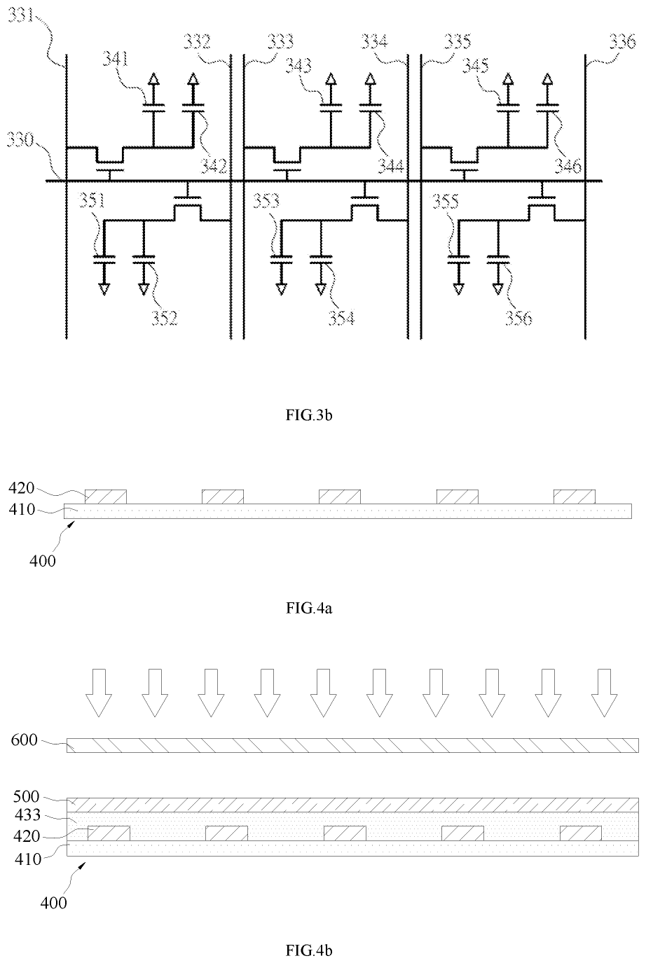

FIG. 3a is a schematic diagram of driving of different color resist layers of a photic zone according to an embodiment of the present application, and FIG. 3b is a drive equivalent circuit diagram of different color resist layers of a photic zone according to an embodiment of the present application. Please refer to FIG. 3a and FIG. 3b, in an embodiment of the present application, a pixel arrangement 100 is provided, including a plurality of pixel assemblies, each of the pixel assemblies including:

a photic zone 300, including a main photic zone 310 and a secondary photic zone 320 adjacent to each other;

a color resist arrangement 305, disposed on the photic zone 300, and the color resist arrangement 305 includes a red color resist layer 312, a green color resist layer 314, a blue color resist layer 316; and a white color resist layer 321, a secondary color resist layer 322, a secondary green color resist layer 324, and a secondary blue color resist layer 326 that are oppositely disposed;

the red color resist layer 312, the green color resist layer 314 and the blue color resist layer 316 are disposed in the main photic zone 310; the white color resist layer 321, the secondary red color resist layer 322, the secondary green color resist layer 324 and the secondary blue color resist layer 326 are disposed at the secondary photic zone 320; the main photic zone 310 and the secondary photic zone 320 are respectively one of a bright zone and a dark zone, depending on a respective input voltage value thereof. For example, when the input voltage of the main photic zone 310 is higher than the input voltage of the secondary photic zone 320, the main photic zone 310 is a bright zone, and the secondary photic zone 320 is a dark zone; otherwise, when the input voltage of the main photic zone 310 is lower than the input voltage of the secondary photic zone 320, the main photic zone 310 is a dark zone, and the secondary photic zone 320 is a bright zone. The cooperation of the bright zone and the dark zone can achieve a low color shift effect.

In the pixel arrangement 100 of an embodiment of the present application, the red color resist layer 312 is disposed opposite to the secondary red color resist layer 322; and the green color resist layer 314 is disposed opposite to the secondary green color resist layer 324; the blue color resist layer 316 is disposed opposite to the secondary blue color resist layer 326.

In the pixel arrangement 100 of an embodiment of the present application, the secondary red color resist layer 322, the secondary green color resist layer 324, and the secondary blue color resist layer 326 are adjacent to each other.

In the pixel arrangement 100 of the embodiment of the present application, the brightness of the main photic zone 310 is higher than the brightness of the secondary photic zone 320 by adjusting the input voltage of the main photic zone 310 and the secondary photic zone 320, wherein the input voltage of the main photic zone 310 is higher than the secondary photic zone 320 to form a different brightness between the main photic zone 310 and a secondary photic zone 320, in which, the main photic zone 310 is a bright zone and the secondary photic zone 320 is a dark zone; otherwise, the input voltages of the main photic zone 310 and the secondary photic zone 320 are adjusted, the brightness the main photic zone 310 is lower than the brightness of the secondary photic zone 320, and the input voltage of the main photic zone 310 is lower than the input voltage of the secondary photic zone 320 such that forming different brightness of the main photic zone and the secondary photic zone, herein, the photic zone 310 is a dark zone and the secondary photic zone 320 is a bright zone.

In the pixel arrangement 100 of an embodiment of the present application, the brightness of the main photic zone 310 is higher than or lower than the brightness of the secondary photic zone 320 by adjusting the magnitude of voltages of the data lines 332, 334, 336 in main photic zone 310 and the data lines 331, 333, 335 in the secondary photic zone 320.

In the pixel arrangement 100 of an embodiment of the present application, the red color resist layer 312, the green color resist layer 314, and the blue color resist layer 316 are in a rectangular shape.

In the pixel arrangement 100 of an embodiment of the present application, the white color resist layer 321, the secondary red color resist layer 322, the secondary green color resist layer 324, and the secondary blue color resist layer 326 are in a rectangular shape.

In the pixel arrangement 100 of an embodiment of the present application, as shown in FIG. 3b, the drive equivalent circuit diagram of the main photic zone 310 and the secondary photic zone 320 color resist layer includes:

a plurality of main liquid crystal capacitors 341, 343, 345;

a plurality of main storage capacitors 342, 344, 346;

a plurality of secondary liquid crystal capacitors 351, 353, 355;

a plurality of secondary storage capacitors 352, 354, 356;

a plurality of scan lines 330 and a plurality of data lines 331, 332, 333, 334, 335, and 336. The main liquid crystal capacitor 341, the secondary liquid crystal capacitor 351, the main storage capacitor 342, the secondary storage capacitor 352 correspond to red color resist layers 312 and secondary red color resist layers 322; a main liquid crystal capacitor 343, a secondary liquid crystal capacitor 353, a main storage capacitor 344, and a secondary storage capacitor 354 correspond to green color resist layers 314 and a secondary green color resist layers 324; the main liquid crystal capacitor 345, the secondary liquid crystal capacitor 355, the main storage capacitor 346, and the secondary storage capacitor 356 correspond to blue color resist layers 316 and a secondary blue color resist layers 326.

Please refer to FIG. 3a and FIG. 3b, in another embodiment of the present application, a pixel arrangement 100 is provided, including a plurality of pixel assemblies, each of pixel assemblies includes:

a photic zone 300, including a main photic zone 310 and a secondary photic zone 320 adjacent to each other;

a color resist arrangement 305, disposed on the photic zone 300, and the color resist arrangement 305 includes a red color resist layer 312, a green color resist layer 314, a blue color resist layer 316; and a white color resist layer 321, a secondary red color resist layer 322, a secondary green color resist layer 324, and a secondary blue color resist layer 326 that are oppositely disposed;

the red color resist layer 312, the green color resist layer 314 and the blue color resist layer 316 are disposed in the main photic zone 310; the white color resist layer 321, the secondary red color resist layer 322, the secondary green color resist layer 324 and the secondary blue color resist layer 326 are disposed at the secondary photic zone 320; the main photic zone 310 and the secondary photic zone 320 are respectively one of a bright zone and a dark zone, depending on a respective input voltage value thereof. For example, when the input voltage of the main photic zone 310 is higher than the input voltage of the secondary photic zone 320, the main photic zone 310 is a bright zone, and the secondary photic zone 320 is a dark zone; otherwise, when the input voltage of the main photic zone 310 is lower than the input voltage of the secondary photic zone 320, the main photic zone 310 is a dark zone, and the secondary photic zone 320 is a bright zone; the cooperation of the bright zone and the dark zone can achieve a low color shift effect; the red color resist layer 312 is disposed opposite to the secondary red color resist layer 322; and the green color resist layer 314 is disposed opposite to the secondary green color resist layer 324; the blue color resist layer 316 is disposed opposite to the secondary blue color resist layer 326; and a proportion of an area of the main photic zone 310 to an area of the secondary photic zone 320 ranges from 1.5 to 4.

In the pixel arrangement 100 of the embodiment of the present application, the brightness of the main photic zone 310 is higher than the brightness of the secondary photic zone 320 by adjusting the input voltage of the main photic zone 310 and the secondary photic zone 320, wherein the input voltage of the main photic zone 310 is higher than the secondary photic zone 320 to form a different brightness between the main photic zone 310 and a secondary photic zone 320, in which, the main photic zone 310 is a bright zone and the secondary photic zone 320 is a dark zone; otherwise, the input voltages of the main photic zone 310 and the secondary photic zone 320 are adjusted, the brightness the main photic zone 310 is lower than the brightness of the secondary photic zone 320, and the input voltage of the main photic zone 310 is lower than the input voltage of the secondary photic zone 320 such that forming different brightness of the main photic zone and the secondary photic zone, herein, the photic zone 310 is a dark zone and the secondary photic zone 320 is a bright zone.

In the pixel arrangement 100 of an embodiment of the present application, the red color resist layer 312, the green color resist layer 314, and the blue color resist layer 316 are in a rectangular shape.

In the pixel arrangement 100 of an embodiment of the present application, the white color resist layer 321, the secondary red color resist layer 322, the secondary green color resist layer 324, and the secondary blue color resist layer 326 are in a rectangular shape.

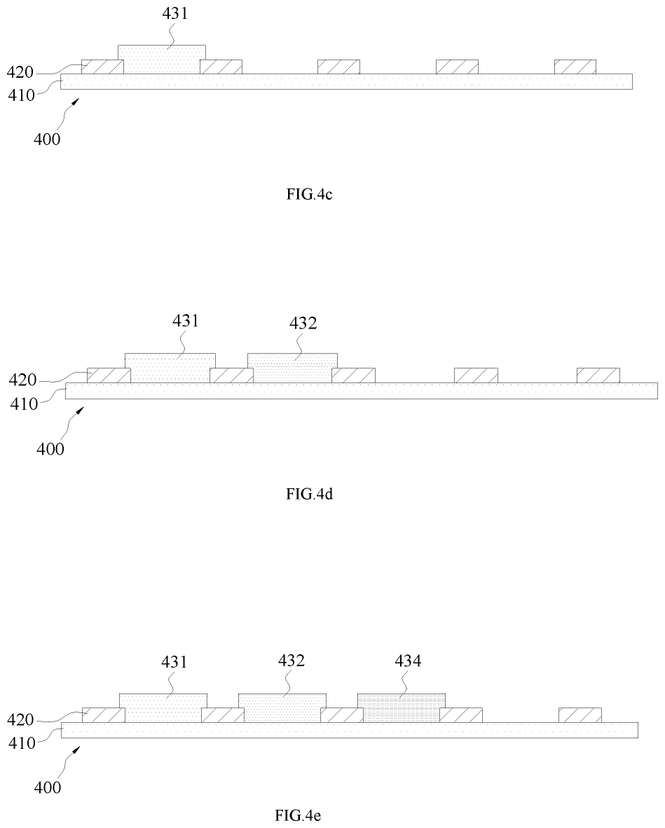

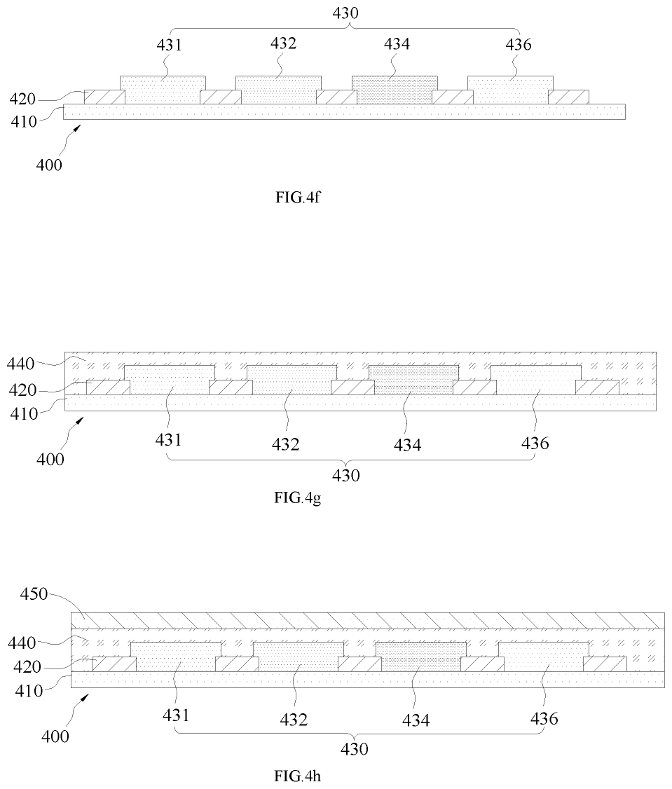

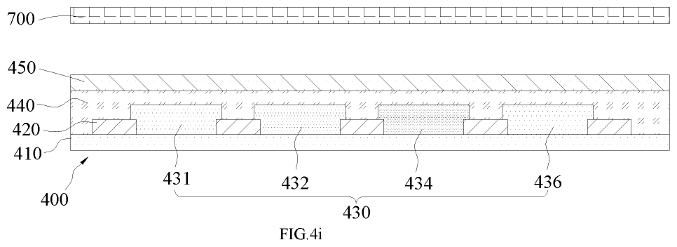

Please refer to FIG. 4a to FIG. 4i, in an embodiment of the present application, a display panel is provided, including: a first substrate 400 with a plurality of pixel areas; a first substrate 400 including a first base 410; and a first insulation layer 420 formed on the first base 410; a second substrate 700 disposed opposite to the first substrate 400; and a liquid crystal layer (not shown) disposed between the first substrate 400 and the second substrate 700; and the pixel arrangement 100 disposed between the first substrate 400 and the second substrate 700.

In an embodiment of the present application, a display device is provided, including a backlight assembly and a display panel, the display panel includes: a first substrate 400 with a plurality of pixel areas; a first substrate 400 including a first base 410; and a first insulation layer 420 formed on the first base 410; a second substrate 700 disposed opposite to the first substrate 400; and a liquid crystal layer (not shown) disposed between the first substrate 400 and the second substrate 700; and the pixel arrangement 100 disposed between the first substrate 400 and the second substrate 700.

Further refer to FIG. 4a to FIG. 4i and FIG. 3a, in another embodiment of the present application, a method for manufacturing a display panel is provided, including:

providing a first base 410, including a plurality of pixel assemblies, the pixel cell includes a photic zone 300, and the photic zone 300 includes an adjacently configured main photic zone 310 and a secondary photic zone 320;

forming a first insulation layer 420 on the first base 410;

forming a color filter layer 430 on the first insulation layer 420, the color filter layer 430 includes color filter layers 431, 432, 434, and 436, the color filter layer 431 is composed of white color resist layers 321; the color filter layer 432 is composed of a red color resist layer 312 and a secondary red color resist layer 322; the color filter layer 434 is composed of a green color resist layer 314 and a secondary green color resist layer 324; and the color filter layer 436 is composed of a blue color resist layer 316 and a secondary blue color resist layer 326; that is, the color filter layer 430 includes a red color resist layer 312, a green color resist layer 314, a blue color resist layer 316; and a white color resist layer 321, a secondary red color resist layer 322, a secondary green color resist layer 324, and a secondary blue color resist layer 326 that are oppositely disposed; in which, the red color resist layer 312, the green color resist layer 314, and the blue color resist layer 316 are disposed on main photic zone 310; the white color resist layer 321, the secondary red color resist layer 322, the secondary green color resist layer 324, and the secondary blue color resist layer 326 are disposed at the secondary photic zone 320;

forming a protection layer 440 on the color filter layer 430;

forming a first electrode layer 450 on the protection layer 440 to complete the first substrate 400;

Providing a second substrate 700 opposite to the first substrate 400 to obtain a display panel;

The main photic zone 310 and the secondary photic zone 320 are respectively one of the bright zone and the dark zone, depending on a respective input voltage value thereof. For example, when the input voltage of the main photic zone 310 is higher than the input voltage of the secondary photic zone 320, the main photic zone 310 is a bright zone, and the secondary photic zone 310 is a dark zone. Otherwise, when the input voltage of the main photic zone 310 is lower than the input voltage of the secondary photic zone 320, the main photic zone 310 is a dark zone, and the secondary photic zone 310 is a bright zone. So that the combination of the bright zone and the dark zone can have a low color shift effect.

In the method for manufacturing a display panel according to an embodiment of the present invention, a spacer is disposed between the first substrate 400 and the second substrate 700 to define a liquid crystal space, and the liquid crystal is filled in the space to form a liquid crystal layer.

In the method for manufacturing the display panel of an embodiment of the present application, please refer to FIG. 4b, the step of forming the color filter layer 430 on the first insulation layer 420 includes: forming a color resist material layer 433 on the entire surface of the first insulation layer 420, and forming a photoresist layer 500 on the color resist material layer 433 to cover the color resist material layer 433; a photomask 600 is disposed on the photoresist layer 500, the photomask 600 has a photic zone, a non-photic zone, and a semi-photic zone; and performing an exposure process and a development process on the photoresist layer 500 to pattern the photoresist layer 500, using the patterned photoresist layer 500 as a barrier layer, and etching the color resist material layer 433 to form a color resist layer corresponding to the color. Adopting the above method to form the white color resist layer 321, the red color resist layer 312, the green color resist layer 314, the blue color resist layer 316, the secondary red color resist layer 322, the secondary green color resist layer 324, and the secondary blue color resist layer 326, in which, the red color resist layer 312, the green color resist layer 314, and the blue color resist layer 316 are sequentially disposed at the main photic zone 310, the secondary red color resist layer 322, the secondary green color resist layer 324, and the secondary blue color resist layer 326 are simultaneously disposed at the secondary photic zone through the same mask; that is, the red color resist layer 312 and the secondary red color resist layer 322 are formed through the same photomask; the green color resist layer 314 and the secondary green color resist layer 324 are formed. through the same photomask; the blue color resist layer 316 and the secondary blue color resist layer 326 are formed through the same photomask.

In the method for manufacturing the display panel of another embodiment of the present application, please refer to FIG. 4b, the step of forming the color filter layer 430 on the first insulation layer 420 includes:

forming a color resist material layer 433 on the entire surface of the first insulation layer 420, and forming a photoresist layer 500 on the color resist material layer 433 to cover the color resist material layer 433; a photomask 600 is disposed on the photoresist layer 500, the photomask 600 has a photic zone, a non-photic zone, and a semi-photic zone; and performing an exposure process and a development process on the photoresist layer 500 to pattern the photoresist layer 500, using the patterned photoresist layer 500 as a barrier layer, and etching the color resist material layer 433 to form a color resist layer corresponding to the color. The white color resist layer 321, the red color resist layer 312, the green color resist layer 314, the blue color resist layer 316, the secondary red color resist layer 322, the secondary green color resist layer 324, and the secondary blue color resist layer 326 are respectively formed by adopting the above method, thereby the color filter is formed, in which, the red color resist layer 312, the green color resist layer 314, and the blue color resist layer 316 are sequentially disposed at the main photic zone 310, the secondary red color resist layer 322, the secondary green color resist layer 324, and the secondary blue color resist layer 326 are simultaneously disposed at the secondary photic zone.

In the method for manufacturing the display panel of the embodiment of the present application, the red color resist layer 312, the green color resist layer 314, and the blue color resist layer 316 are in a rectangular shape.

In the method for manufacturing the display panel of the embodiment of the present application, the white color resist layer 321, the secondary red color resist layer 322, the secondary green color resist layer 324, and the secondary blue color resist layer 326 are in a rectangular shape.

Each of the pixel assemblies in the present application are configured to include a main photic zone 210 and a secondary photic zone 320 adjacent to each other, and the main photic zone 310 and the secondary photic zone 320 are respectively one of a bright zone and a dark zone, depending on a respective input voltage value thereof, so there is a multi-category compensation effect under the large viewing angle, such that the bright zone and the dark zone cooperate with each other to achieve a low color shift effect, in addition, the area proportion of bright area to dark area is appropriately adjusted, and the whitening or color shift problem of the large viewing angle of the display panel can be effectively solved.

The aforementioned embodiments are only optional embodiments of the present application, and should not be regarded as being limitation to the present application. Any modification, equivalent replacement, improvement, and so on, which are made within the spirit and the principle of the present application, should be included in the protection scope of the present application.

1-15. (canceled)

16. A pixel arrangement, comprising a plurality of pixel cells, each pixel cell comprising:
a photic zone, comprising a main photic zone and a secondary photic zone adjacent to each other;
a color resist arrangement, disposed at the photic zone, the color resist arrangement comprising: a red color resist layer, a green color resist layer, a blue color resist layer; and a white color resist layer, a secondary red color resist layer, a secondary green a color resist layer, and a secondary blue color resist layer that are oppositely disposed;
wherein the red color resist layer, the green color resist layer, and the blue color resist layer are disposed at the main photic zone; the white color resist layer, the secondary red color resist layer, the secondary green color resist layer, and the secondary blue color resist layer are disposed at the secondary photic zone; the main photic zone and the secondary photic zone are respectively one of a bright zone and a dark zone, depending on a respective input voltage value thereof.

17. The pixel arrangement of claim 16, wherein the red color resist layer is disposed opposite to the secondary red color resist layer, the green color resist layer is disposed opposite to the secondary green color resist layer, and the blue color resist layer is disposed opposite to the secondary blue color resist layer.

18. The pixel arrangement of claim 16, wherein the secondary red color resist layer, the secondary green color resist layer, and the secondary blue color resist layer are disposed sequentially.

19. The pixel arrangement of claim 16, wherein an input voltage of the main photic zone and an input voltage of the secondary photic zone are adjustable such that a brightness of the main photic zone is higher than a brightness of the secondary photic zone.

20. The pixel arrangement of claim 16, wherein the red color resist layer, the green color resist layer, and the blue color resist layer are in a rectangular shape.

21. The pixel arrangement of claim 16, wherein the white color resist layer, the secondary red color resist layer, the secondary green color resist layer, and the secondary blue color resist layer are in a rectangular shape.

22. A pixel arrangement, comprising a plurality of pixel assemblies, the pixel cell comprising:
a photic zone, comprising a main photic zone and a secondary photic zone adjacent to each other;
a color resist arrangement, disposed on the photic zone, the color resist arrangement comprising: a red color resist layer, a green color resist layer, a blue color resist layer; and a white color resist layer, a secondary red color resist layer, a secondary color resist layer and a secondary blue color resist layer that are oppositely disposed;
wherein the red color resist layer, the green color resist layer, and the blue color resist layer are disposed at the main photic zone; the white color resist layer, the secondary red color resist layer, the secondary green color resist layer, and the secondary blue color resist layer are disposed at the secondary photic zone; the main photic zone and the secondary photic zone are respectively one of a bright zone and a dark zone, depending on a respective input voltage value thereof; the red color resist layer is disposed opposite to the secondary red color resist layer, the green color resist layer is disposed opposite to the secondary green color resist layer, and the blue color resist layer is disposed opposite to the secondary blue color resist layer; the secondary red color resist layer, the secondary green color resist layer, and the secondary blue color resist layer are disposed sequentially; and a proportion of an area of the main photic zone to an area of the secondary photic zone ranges from 1.5 to 4.

23. The pixel arrangement of claim 22, wherein the input voltage of the main photic zone and the input voltage of the secondary photic zone are adjustable such that a brightness of the main photic zone is higher than a brightness of the secondary photic zone.

24. The pixel arrangement of claim 22, wherein the red color resist layer, the green color resist layer, and the blue color resist layer are in a rectangular shape.

25. The pixel arrangement of claim 22, wherein the white color resist layer, the secondary red color resist layer, the secondary green color resist layer, and the secondary blue color resist layer are in a rectangular shape.

26. A method for manufacturing a display panel, comprising:
providing a first base, the first substrate comprising a plurality of pixel assemblies, wherein each pixel cell comprises a photic zone, and the photic zone comprises a main photic zone and a secondary photic zone adjacent to each other;
forming a first insulation layer on the first base;
forming a color filter layer on the first insulation layer, wherein the color filter layer comprises a red color resist layer, a green color resist layer, a blue color resist layer; and a white color resist layer, a secondary red color resist layer, a secondary color resist layer and a secondary blue color resist layer that are oppositely disposed; wherein the red color resist layer, the green color resist layer, and the blue color resist layer are disposed at the main photic zone; the secondary red color resist layer, the secondary green color resist layer, and the secondary blue color resist layer are disposed at the secondary photic zone;
forming a protection layer on the color filter layer;
forming a first electrode layer on the protection layer to complete the first substrate;
providing a second substrate disposed opposite to the first substrate to form the display panel;
the main photic zone and the secondary photic zone are respectively one of a bright zone and a dark zone, depending on a respective input voltage value thereof.

27. The method of claim 26, wherein the step of forming a color filter layer on the first insulation layer comprising:
forming a color resist material layer on an entire surface of the first insulation layer;
forming a photoresist layer on the color resist material layer to cover the color resist material layer;
disposing a photomask on the photoresist layer, wherein the photomask has a photic zone, a non-photic zone, and a semi-photic zone;
performing an exposure process and a development process on the photoresist layer for patterning the photoresist layer; and
using the photoresist layer as a barrier layer, etching the color resist material layer to form a color resist layer of a corresponding color.

28. The method of claim 27, wherein he step of forming a color filter layer on the first insulation layer further comprising:
manufacturing the white color resist layer, the red color resist layer, the green color resist layer, the blue color resist layer, the secondary red color resist layer, the secondary green color resist layer, and the secondary blue color resist layer; wherein the red color resist layer and the secondary red color resist layer are manufactured by a same photomask process, the green color resist layer and the secondary green color resist layer are manufactured by a same photomask process, and the blue color resist layer and the secondary blue color resist layer are manufactured by a same photomask process to form the color filter layer.

29. The method of claim 26, wherein the step of forming a color filter layer on the first insulation layer comprising:
forming a color resist material layer on an entire surface of the first insulation layer;
forming a photoresist layer on the color resist material layer to cover the color resist material layer;
disposing a photomask on the photoresist layer, wherein the photomask has a photic zone, a non-photic zone, and a semi-photic zone;
performing an exposure process and a development process on the photoresist layer for patterning the photoresist layer; and
using the photoresist layer as a barrier layer, etching the color resist material layer to form a color resist layer of a corresponding color.

30. The method of claim 29, wherein the step of forming a color filter layer on the first insulation layer further comprising:
respectively manufacturing the white color resist layer, the red color resist layer, the green color resist layer, the blue color resist layer, the secondary red color resist layer, the secondary green color resist layer and the blue color resist layer in a method described above to form the color filter layer.

31. The method of claim 26, wherein the method further comprising:
disposing a spacer between the first substrate and the second substrate to define a liquid crystal space, and a liquid crystal is filled in the space to form a liquid crystal layer.

32. The method of claim 26, wherein the red color resist layer, the green color resist layer, and the blue color resist layer are in a rectangular shape.

33. The method of claim 26, wherein the white color resist layer, the secondary red color resist layer, the secondary green color resist layer, and the secondary blue color resist layer are in a rectangular shape.
